(19) United States
(12) Patent Application Publication
(10) Pub. No.: US 2026/0199180 A1
(43) Pub. Date: Jul. 16, 2026

(54) DISPENSER FOR HEATED LUBRICANT IN SEXUAL STIMULATION DEVICE

(71) Applicant: HYTTO PTE. LTD., Singapore (SG)

(72) Inventors: Zhiwen Wu, Guangdong (CN); Renshi Yang, Guangdong (CN)

(21) Appl. No.: 19/427,013

(22) Filed: Dec. 19, 2025

Related U.S. Application Data
(63) Continuation-in-part of application No. 19/296,486, filed on Aug. 11, 2025.
Application No. 19/296,486 is a continuation-in-part of application No. 18/629,191, filed on Apr. 8, 2024, now Pat. No. 12,433,817.

(30) Foreign Application Priority Data
Oct. 13, 2025 (CN) 2025221596259

(51) Int. Cl. A61H 19/00

(52) U.S. Cl. CPC A61H 19/32; A61H 2201/0207; A61H 2201/5007

(57) ABSTRACT

A dispenser for heated liquid includes a storage container configured to store liquid. An output portion is configured to output at least part of the liquid at a target temperature to achieve tactile comfort for a sensitive area of a user. A liquid transfer assembly is configured to deliver the at least of the liquid from the storage container to the output portion while preserving the liquid remained in the storage container at an initial temperature. The target temperature of the at least part of the liquid is higher than the initial temperature of the liquid remained in the storage container.

### CROSS-REFERENCE TO RELATED APPLICATION

The present application is a Continuation-In-Part of co-pending U.S. patent application Ser. No. 19/296,486, filed on Aug. 11, 2025, which is a Continuation-In-Part of U.S. patent application Ser. No. 18/629,191, filed Apr. 8, 2024. The present application also claims priority under 35 U.S.C. § 119 to CN 2025221596259 filed on Oct. 13, 2025. The disclosures of these applications are incorporated by reference herein in their entireties.

### TECHNICAL FIELD

The present disclosure relates to a sexual stimulation device and, more specifically, to a dispenser for heated lubricant in a sexual stimulation device.

### DISCUSSION OF THE RELATED ART

Sexual stimulation devices, which are designed to enhance sexual experiences and/or provide therapeutic benefits, have become widely used in the fields of personal care and health. Common male-oriented stimulation devices often include a flexible massage body with an internal channel or cavity that mimics the structure and tactile sensation of the vagina, thereby providing smooth, comfortable, and realistic stimulation to the penis of a male user. Female-oriented stimulation devices frequently utilize an elongated, rod-shaped flexible massage body that simulates a penis to deliver stimulation to the vagina of a female user. During use of such devices, users typically apply lubricants or other liquids to enhance comfort and improve overall sensory experience.

However, lubricants stored in conventional containers are usually kept at room temperature, which is noticeably lower than human body temperature. This temperature disparity may cause discomfort upon application and can diminish the sense of realism and immersion during use.

To address this issue and further improve realism and comfort, lubricant-heating features may be integrated into sexual stimulation devices. One approach may involve embedding heating elements around or within the lubricant storage container to pre-warm the entire volume of stored lubricant to approximately body temperature. While this full-volume preheating method can provide warm lubricant, it introduces several drawbacks. Many lubricants are sensitive to temperature changes, repeated heating, and subsequent cooling cycles. For example, heating these lubricants before each use may allow for unused portions of the lubricant to cool off and then reheating them during later uses can lead to evaporation of the lubricant solvent (e.g., evaporation of water within a water-based lubricant). Moreover, the repeated heating and colling may result in other chemical changes to the lubricant. These changes may substantially increase viscosity and cause stickiness within the lubricant, ultimately degrading the lubricant's performance. Once the lubricant has deteriorated, it may not only fail to provide effective lubrication but also cause user discomfort due to excessive viscosity. To combat this effect, users of such devices may be required to discard the remaining lubricant in the container after each use, resulting in undesirable waste.

### SUMMARY

A dispenser for heated liquid includes a storage container configured to store liquid. An output portion is configured to output at least part of the liquid at a target temperature to achieve tactile comfort for a sensitive area of a user. A liquid transfer assembly is configured to deliver the at least part of the liquid from the storage container to the output portion while preserving the liquid remained in the storage container at an initial temperature. The target temperature of the at least part of the liquid is higher than the initial temperature of the liquid remained in the storage container.

The dispenser may further include a heating assembly that may be configured to heat the at least part of the liquid to the target temperature as it moves through the liquid transfer assembly.

The heating assembly may be an instantaneous on-demand heating assembly.

The heating assembly may be configured to have a heating rate of not less than 20 C. /s from room temperature.

The heating assembly may be configured to heat the at least part of the liquid to the target temperature as it moves through the heating assembly, in a contactless manner.

The heating assembly may include a rare earth thick film element or a nanostructured thick film element.

An outer layer of the heating assembly may include a thermal insulation structure.

The liquid transfer assembly may include a liquid controller configured to control a flow of the at least part of the liquid, in a contactless manner.

The liquid transfer assembly may include a peristaltic pump.

The liquid transfer assembly may include a flexible pipeline section, and wherein the liquid controller includes a regulator that contacts an outer wall of the flexible pipeline section to regulate liquid flow in the flexible pipeline section.

The dispenser may further include one or more temperature sensors, at least one of which is disposed adjacent to the output portion.

A sexual stimulation device includes a storage container configured to store liquid. A sexual massage assembly is configured to apply sexual stimulation to a sensitive area of a user. A liquid transfer assembly is configured to deliver at least part of the liquid from the storage container and output the at least part of the liquid to the sexual massage assembly at a target temperature to achieve tactile comfort for the sensitive area of the user while preserving the liquid remained in the storage container at an initial temperature. The target temperature of the at least part of the liquid is higher than the initial temperature of the liquid remained in the storage container.

At least a partial pipeline of the liquid transfer assembly may be configured in a serpentine or maze shape to lengthen a preheating and flow path of the liquid transfer assembly.

The serpentine or maze shape of the partial pipeline may be configured in a flat layout and integrated to a bottom of a flexible massage body of the sexual massage assembly to reduce space occupancy of the sexual stimulation device.

The serpentine shape of the partial pipeline may be configured in a spatial layout and integrated to be beside or surround a flexible massage body of the sexual massage assembly to reduce space occupancy of the sexual stimulation device and provide a preheating function to the flexible massage body.

The liquid transfer assembly may be configured to indirectly heat the sexual massage assembly by delivering the at least part of the liquid, at the target temperature, so as to apply warm tactile stimulation to the sensitive area of the user as the at least part of the liquid, at the target temperature, moves through an output portion to the sexual massage assembly.

The sexual massage assembly may be a male-oriented sexual stimulation assembly including a flexible massage channel. The liquid transfer assembly may be configured to deliver the at least part of the liquid to the flexible massage channel.

The liquid transfer assembly may include a liquid controller component configured to control a flow of the liquid, which constitutes a first liquid, from the storage container to the sexual massage assembly, and to control a flow of a second fluid from a second container storing cleaning liquid and/or water to the sexual massage assembly.

The storage container may be connected to the sexual massage assembly via a quick disassembly arrangement.

The storage container may include a slot configured to receive a single-use capsule that includes only the at least part of the liquid.

### BRIEF DESCRIPTION

A more complete appreciation of the present disclosure and many of the attendant aspects thereof will be readily obtained as the same becomes better understood by reference to the following detailed description when considered in connection with the accompanying drawings, wherein:

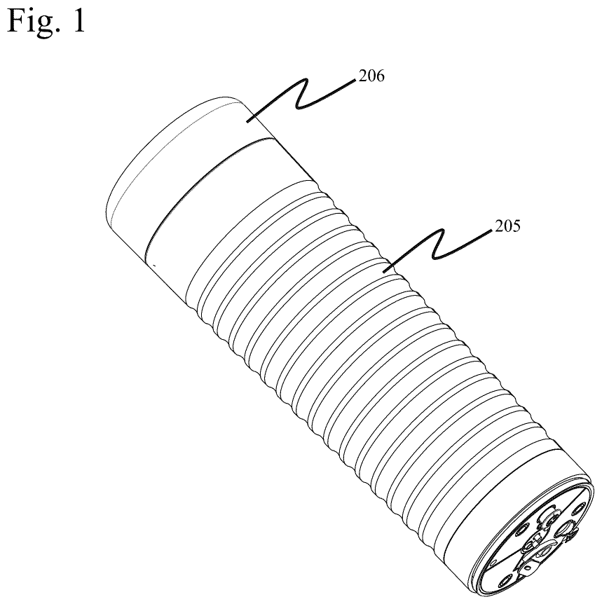

FIG. 1 is a perspective view illustrating a sexual stimulation device in accordance with exemplary embodiments of the present disclosure;

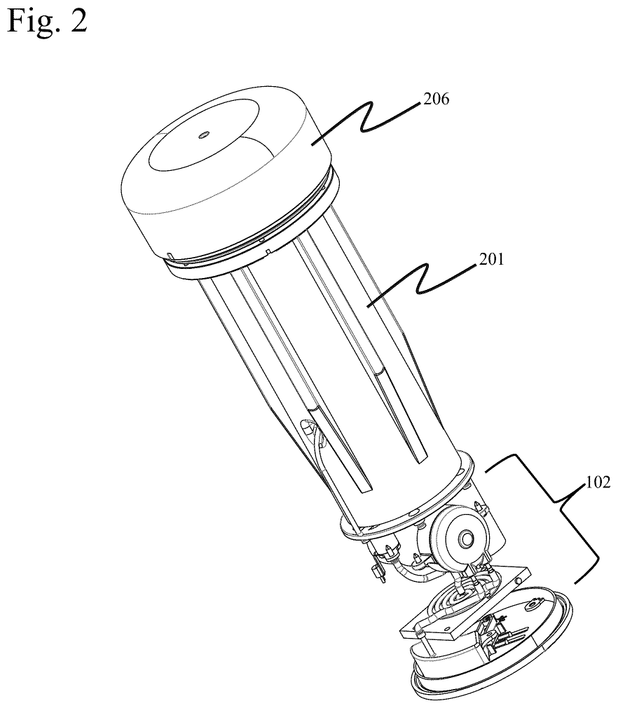

FIG. 2 is a perspective view illustrating the sexual stimulation device of FIG. 1, with the housing thereof removed so as to illustrate the internal components;

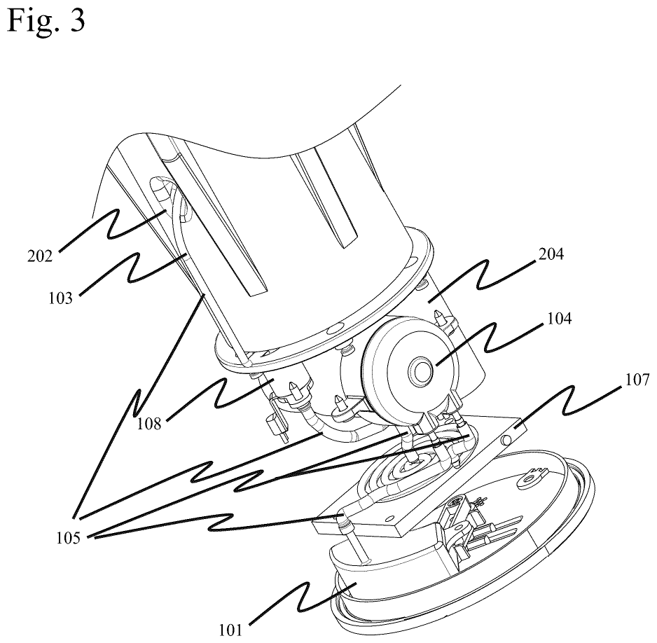

FIG. 3 is a perspective view illustrating a closeup of a lower section of the sexual stimulation device of FIG. 1;

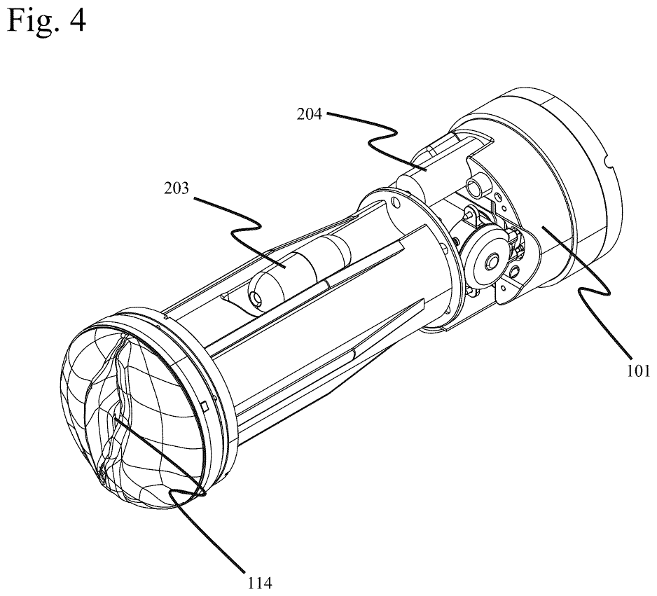

FIG. 4 is a perspective view illustrating the sexual stimulation device of FIG. 1, with the housing and cover thereof removed, in a perspective view;

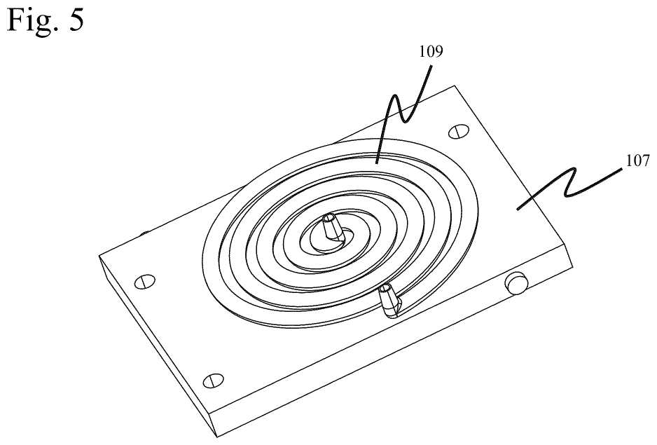

FIG. 5 is a perspective view illustrating a segment of the liquid transfer pipeline, as viewed from a top-down perspective, configured for heat exchange in accordance with exemplary embodiments of the present disclosure;

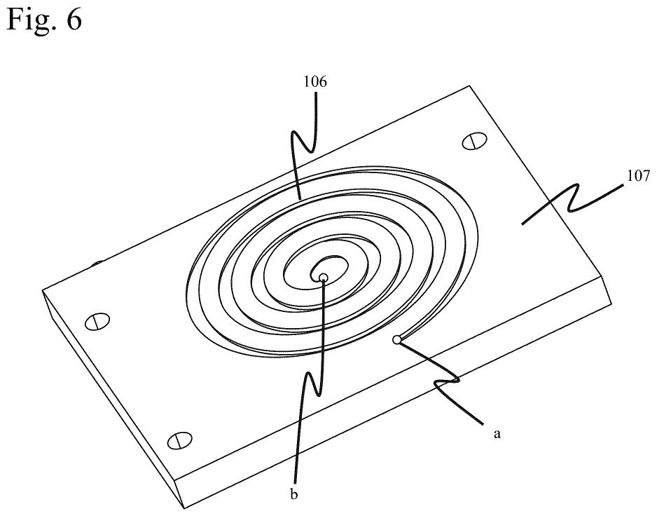

FIG. 6 is a perspective view illustrating a segment of the heating assembly, as viewed from a bottom-up perspective;

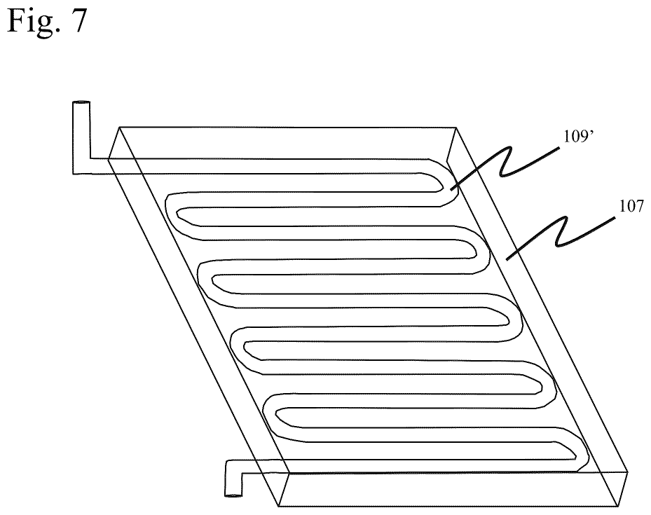

FIG. 7 is a perspective view illustrating a segment of the liquid transfer pipeline that takes the form of a rectangular serpentine pattern, in accordance with exemplary embodiments of the present disclosure;

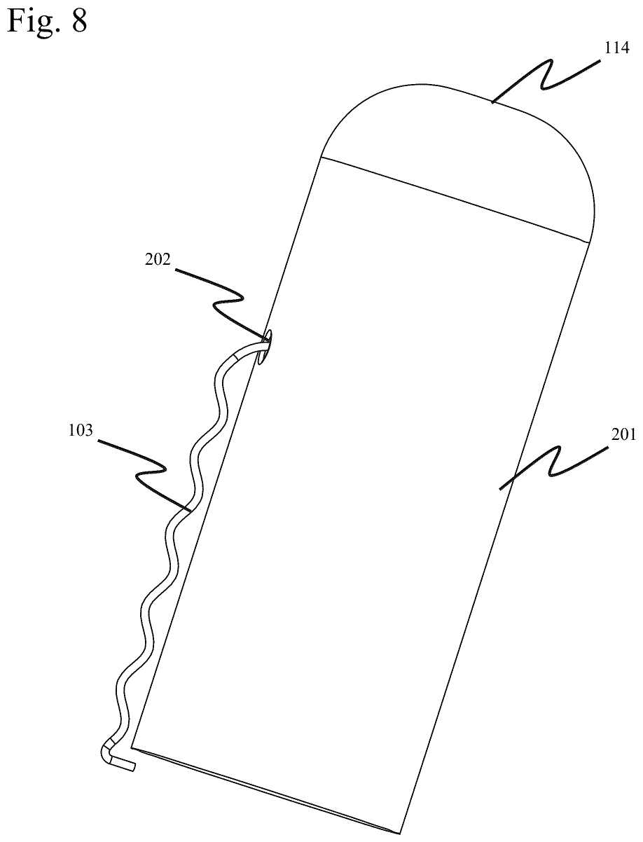

FIG. 8 is a simplified schematic side view illustrating a manner in which the liquid transfer pipeline connects to the flexible massage body, in accordance with exemplary embodiments of the present disclosure;

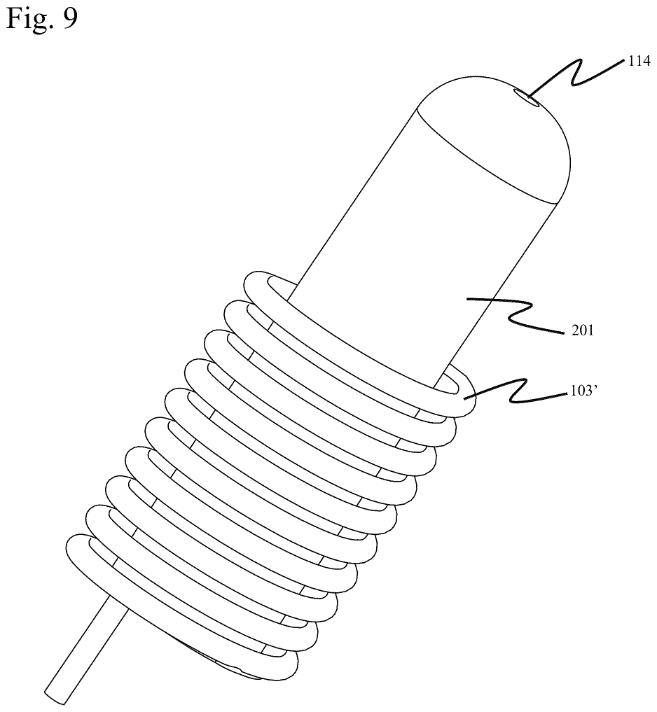

FIG. 9 is a simplified schematic side view illustrating a manner in which the liquid transfer pipeline connects to the flexible massage body, in accordance with exemplary embodiments of the present disclosure;

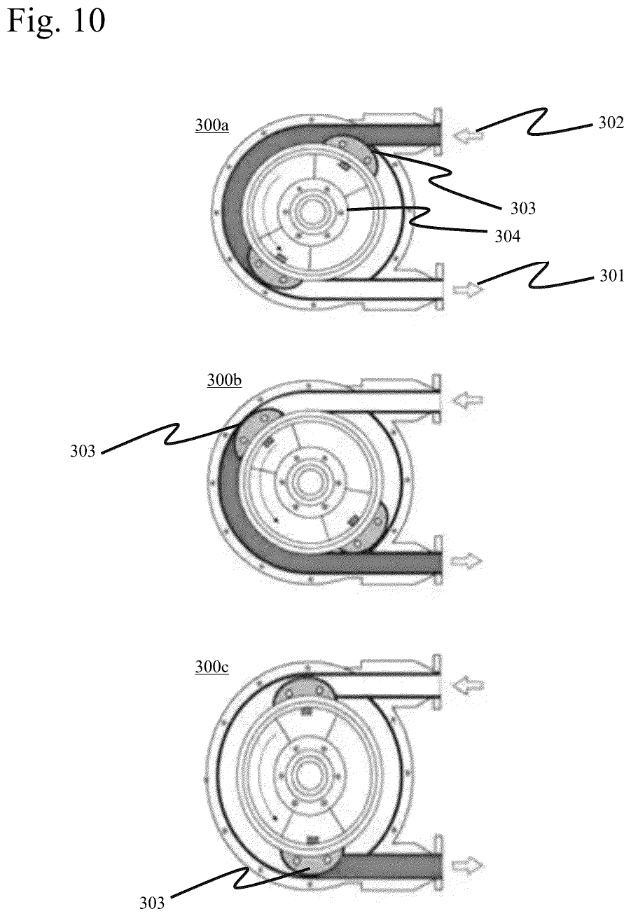

FIG. 10 is a sequence of simplified schematic views illustrating a peristaltic pump in accordance with exemplary embodiments of the present disclosure;

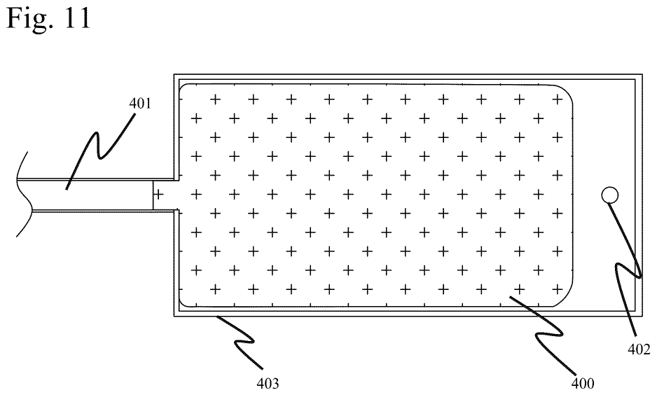

FIG. 11 is a simplified view illustrating a storage container in accordance with exemplary embodiments of the present disclosure; and

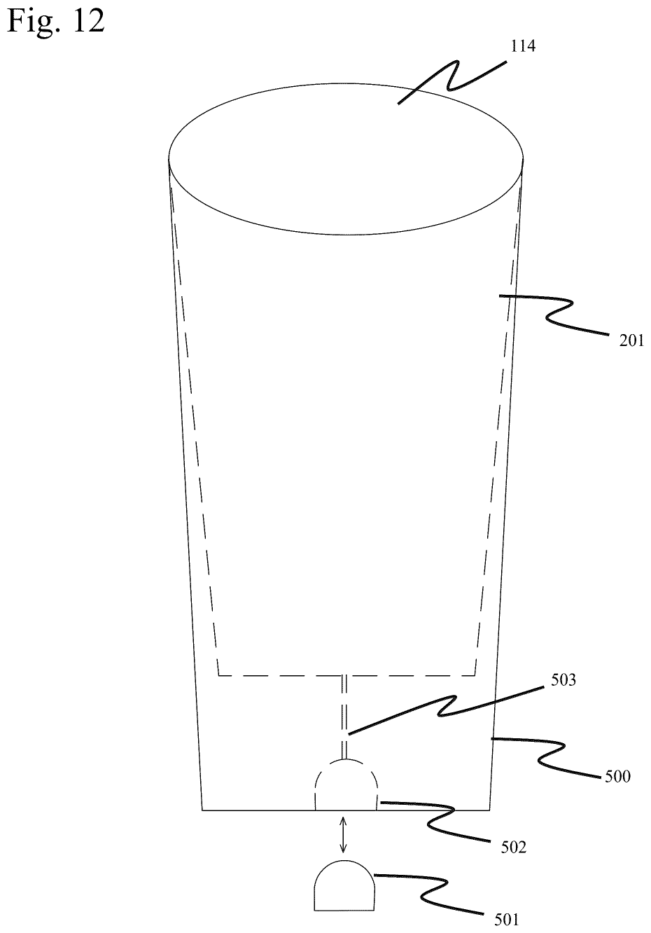

FIG. 12 is a simplified view illustrating a device that utilizes a single-use capsule for fluid supply, in accordance with an exemplary embodiment of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure pertain to a sexual stimulation device that improves comfort and realism by supplying a heated dose of liquid (e.g., a liquid that may be used to enhance sexual stimulation, or improve sexual health, or enhance sexual wellness, or improve sexual pleasure, or prevent pregnancy, such as a lubricant, arousal liquid, climax delay liquid, anti-inflammatory liquid, contraception liquid, etc.), that is heated at the moment of use, as it is dispensed, rather than preheating an entire storage container of the fluid. The device keeps the bulk of the liquid at room temperature in a storage container to preserve its chemical stability, while an in-line on-demand heating assembly rapidly heats a small amount of liquid as it travels through a liquid transfer pipeline, so that the liquid may be deployed at a body-like temperature to the sexual massage assembly or human body (e.g., a sensitive area of a user, such as penis, vagina and vulva). This avoids degradation or waste caused by repeated heating and cooling of stored lubricant. The heating is performed indirectly and non-contact, often through rare earth thick film elements or nano thick film components, ensuring hygiene and efficiency. A peristaltic pump or alternative liquid control element moves the liquid without exposing it to mechanical parts, and temperature sensors prevent overheating. In some embodiments, the liquid may also heat the massage body itself to enhance tactile sensation. An alternative embodiment uses single-dose capsules containing liquid therein that can be heated entirely after the capsule is deployed into the device, eliminating concerns about leftover liquid. Overall, embodiments of the present disclosure may provide a hygienic, controlled, and instantly warm liquid delivery system that enhances user's sexual experience while preventing fluid deterioration and unnecessary waste.

FIGS. 1 through 4 illustrate a sexual stimulation device includes a sexual massage assembly and a dispenser for heated liquid. The dispenser, which may be a component for achieving tactile comfort for a sensitive area of a user and enhancing sexual experience, may be used in conjunction with a sexual massage assembly. But it is noted that the dispenser could also be used alone as an independent device for providing warm fluid. It is also noted that while the dispensed liquid may be referred to herein as a lubricant, arousal liquid, climax delay liquid, anti-inflammatory liquid, contraception liquid, it is to be understood that the liquid may alternatively be or include a cleaning fluid that is heated during a self-cleaning mode. The dispenser may include a storage container 101 for storing liquid, an output portion for outputting at least part of the liquid at a target temperature to achieve tactile comfort for the sensitive area of the user, and a liquid transfer assembly 102 which is configured to deliver the at least part of the liquid to the output portion while preserving the liquid remained in the storage container at an initial temperature. The output portion may be an output channel 103 or an applicator head or a spray head. For example, the output portion may be an applicator head or a spray head when the dispenser is used alone as an independent device for providing warm fluid. The output portion may be an output channel 103 which is configured to output liquid to the sexual massage assembly when the dispenser is used in conjunction with the sexual massage assembly. The output channel 103 may be a part of the liquid transfer assembly 102. The liquid transfer assembly 102 may include one or more liquid transfer pipelines 105. A target temperature of the at least part of liquid, when it reaches the output channel 103, may be higher than the initial temperature remained in the storage container 101. Using the dispenser could provide users with warm and comfortable liquid, such as a lubricant, with a suitable temperature to enhance their sexual experience, while effectively avoiding premature deterioration and failure of the liquid due to repeated heating, and also potentially reducing waste of the liquid. The liquid may include a lubricant, as discussed above, but may alternatively or additionally include ingredients that improve sexual function, ingredients that treat diseases/reduce disease transmission, and so on. The lubricant could be used to reduce friction, increase comfort, and enhance pleasure. Examples of liquid containing ingredients that improve sexual function may include ingredients for delaying orgasm, adding to arousal, or ingredients that may act as aphrodisiacs. The liquid containing ingredients that treat diseases/reduce disease transmission may include antimicrobial ingredient, preservatives, antiseptics, antibiotics, antifungals, antivirals, etc. These liquids may achieve maximum efficacy when their temperature approaches human body temperature. These liquids are not heated while stored inside the storage container 101, allowing the liquid in the storage container 101 to maintain its initial temperature and physical and chemical properties. The initial temperature may be room temperature or a temperature which would not degrade inherent performance of the liquid. Additionally, the storage container 101 may further be insulated or actively cooled, so as to preserve freshness, where desired.

The sexual stimulation device may heat the liquid that is about to flow towards the sexual stimulation assembly, rather than heating the liquid while it is stored in the storage container 101, thereby achieving automatic dispensation of warm liquid without the need for the liquid to be touched with hands, providing a comfortable, clean, and uninterrupted sexual experience, and avoiding waste and failure of the liquid due to repeated heating.

The liquid transfer assembly 102 is configured to indirectly heat the sexual stimulation assembly by delivering heated liquid so as to apply warm tactile stimulation to the sensitive area of the user as the at least part of the liquid, at the target temperature, moves through the output portion to the sexual massage assembly, without the need to directly preheat the sexual stimulation assembly itself. Thus, the user could experience warm, comfortable stimulation once the heated liquid reaches the sexual stimulation assembly, by virtue of the heated liquid warming the sexual stimulation assembly, without the need to install a separate heating component for heating the sexual stimulation assembly.

In this embodiment, the sexual stimulation assembly is a male-oriented sexual stimulation assembly with a flexible massage body 201, the liquid transfer assembly 102 comprising the liquid transfer pipeline 105 is configured to deliver at least part of liquid to the flexible massage body 201. In other embodiments, the sexual stimulation assembly could also be a female-oriented sexual stimulation assembly. The liquid transfer assembly 102 comprising the liquid transfer pipeline 105 may be configured to deliver at least part of liquid to a flexible external layer of the female-oriented sexual stimulation assembly.

The sexual stimulation device may further include a heating assembly configured to heat at least a part of liquid which flows out from the storage container 101 to the output channel 103. For example, the heating assembly may be an instantaneous, on-demand, heating assembly. An instantaneous, on-demand, heating assembly is a heating structure with a very fast heating speed, which can quickly heat the liquid when the user needs it, without the perception of any delay by the user. The heating assembly could be configured to have a heating rate of not less than 20° C./s, for example, 20-300° C./s, like 20° C./s , 50 ° C./s, 80° C./s, 100° C./s, 200° C./s, 300° C./s, and so on, when starting from room temperature. The heating assembly can utilize a rare earth thick film element or a nanostructured thick film element as a core heating element. Rare earth thick film element is an element that utilize rare earth thick film technology to achieve rapid heating. The heating material in such a case may be a thick film resistor made by combining rare earth elements with a metal substrate. The rare earth thick film resistor may be connected between two power terminals (for example, power terminals “a” and “b”, shown in FIG. 6) and thereby generate heat when electrified. The heating rate of rare earth thick film components can reach up to 200-300° C./s, when starting from room temperature. Nano thick film element may utilize nanomaterials for rapid heating. The heating material may be a resistor sheet coated with a nano-silver film, which enables fast heating through the high thermal conductivity of nanomaterials. The heating rate of nano thick film components can reach up to 150-300° C./and so may be well suited for use in such a context.

FIG. 1 is a perspective view illustrating a sexual stimulation device in accordance with exemplary embodiments of the present disclosure. As may be appreciated from this figure, the sexual stimulation device may include a housing 205 that encloses the electrical and mechanical components of the device, as well as a cover 206 that seals the device.

FIG. 2 is a perspective view illustrating the sexual stimulation device of FIG. 1, with the housing 205 thereof removed so as to illustrate the internal components. As can be appreciated from this figure, a flexible massage body 201 may be used as an example of a part of a suitable sexual stimulation assembly, for example, one that is male-oriented, which is to say, designed to provide sexual stimulation to a penis. The flexible massage body may receive heated liquid from a liquid transfer assembly 102.

FIG. 3 is a perspective view illustrating a closeup of a lower section of the sexual stimulation device of FIG. 1, with the housing 205 thereof removed. As can be appreciated from this figure, the liquid inlet openings 202, which lead to an interior of the flexible massage body 201, may receive heated liquid from an output channel 103. The output channel 103 may be part of a liquid transfer pipeline 105 that is configured to transport liquid from the storage container 101 to the liquid inlet openings 202, while heating the liquid along the way.

The liquid transfer assembly 102 may also include a liquid controller 104 (for example, a rotary peristaltic pump) which is configured to move the liquid along the liquid transfer pipeline 105, such as by a pumping action. One or more temperature sensors 108 may be disposed within the liquid transfer pipeline 105 or the output portion, for example, close to the liquid inlet openings 202 so as to provide temperature feedback to a control module and a thermal conductive plate 107 that is configured to heat the liquid within the liquid transfer pipeline 105. A power supply 204, such as a rechargeable or replaceable battery, may be configured to power the thermal conductive plate 107, the liquid controller 104, vibration/motion elements of the sexual stimulation assembly, and/or the various other components of the sexual stimulation device.

FIG. 4 is a perspective view illustrating the sexual stimulation device of FIG. 1, with the housing 205 and the cover 206 thereof removed, as shown in FIG. 2, but from a second perspective. Here a vibrator 203 of the sexual stimulation assembly may be seen as pressing up against the flexible massage body 201. In this view, an opening 114 to the flexible massage body 201 may be seen.

According to embodiments of the present disclosure, the liquid transfer assembly 102 may include a liquid controller 104 configured to control liquid flow through the liquid transfer pipeline 105. The liquid controller 104 may control such attributes as flow direction, flow velocity, and/or flow rate. Additionally, at least a portion of the liquid transfer pipeline 105 may be configured as a flat disk-like shape, for example, a segment of the liquid transfer pipeline 105 may be coiled into a circular disk-shape, as may be appreciated from FIG. 4, or into a rectangular serpentine pattern, as may be appreciated from FIG. 7. Such a structure may be referred to herein as a planar coiled pipeline and it may be characterized as having a disk, rectangular, or serpentine shape. These coiled configurations can help reduce the assembly space occupied by the liquid transfer assembly inside the sexual stimulation device, thereby minimizing the overall size of the device.

According to embodiments of the present disclosure, a partial pipeline of the liquid transfer assembly is configured in a serpentine or maze shape to lengthen a preheating and flow path of the liquid transfer assembly. As an optional implementation, the serpentine or maze shape of the partial pipeline is configured in a flat layout and integrated to a bottom of the flexible massage body of the sexual massage assembly to reduce space occupancy of the sexual stimulation device. FIG. 5 is a perspective view illustrating a segment of the liquid transfer pipeline 105, as viewed from a top-down perspective, configured for heat exchange in accordance with exemplary embodiments of the present disclosure. FIG. 6 is a perspective view illustrating a segment of the heating assembly, as viewed from a bottom-up perspective. As may be appreciated from these figures, heat exchange may be performed by running a portion of the liquid transfer pipeline 105 in a planar coil, here depicted as a disk-shaped coil 109. This disk-shaped coil 109 may be disposed on a thermal conductive plate 107. A planar heating element, such as a rare earth thick film element 106 may be disposed over the disk-shaped coil 109. The rare earth thick film element 106 may be formed on side surface of the thermal conductive plate 107 through processes such as printing and sintering or coating, and it may be configured to rapidly generate high heat when energized and thereby cause the temperature of the entire thermal conductive plate to rise quickly. The heat is then transferred through the thermal conductive plate 107 to the disk-shaped coil 109 attached to an opposite side surface of the thermal conductive plate 107, thereby heating the liquid flowing inside the disk-shaped coil 109 on its way from the storage container 101 and to the liquid inlet opening 202. Alternatively, in other embodiments, the disk-shaped coil 109 may be configured to be directly embedded inside the thermal conductive plate, or further integrated into a monolithic structure. The rare earth thick film element 106 may then be arranged on one or both outer side surfaces of the thermal conductive plate.

To prevent the high heat of the heating assembly from damaging other parts of the device (particularly the sexual stimulation assembly) and to ensure user's safety, an outer layer of the heating assembly may be equipped with a thermal insulation structure that may, for example, encapsulate the thermal conductive plate 107, the disk-shaped coil 109, and the rare earth thick film element 106, which together may be contemplated as the heating assembly. For example, a protective shell can be installed outside of the rare earth thick film element 106, and a thermal insulation cavity can be formed between the protective shell and the rare earth thick film element 106, or an insulation layer or insulation pad can be filled between the protective shell and the thick-film element. The insulation layer can be made of materials such as an aluminum reflective layer or a hollow glass microsphere layer. The insulation pad can preferably be made of a heat-resistant foamed silicone pad.

As may be appreciated from FIG. 6, the rare earth thick film element 106 may include two power terminals “a” and “b” that may be connected to an electrical source to initiate heat generation. It is to be noted, however, that the heating element is not necessarily limited to the use of a rare earth thick film element 106 and any heating element, such as another form of eclectically resistive element, may be used.

FIG. 7 is a perspective view illustrating a segment of the liquid transfer pipeline 105 that takes the form of a rectangular serpentine pattern 109′, in accordance with exemplary embodiments of the present disclosure. Here, the rectangular serpentine pattern 109′ may be disposed on either a top surface, a bottom surface, or within the thermal conductive plate 107, and the rare earth thick film element 106 may be disposed thereupon.

In this way, liquid may flow through the liquid transfer pipeline 105 so as to be extruded, as a heated liquid, into the flexible massage body 201 through the liquid inlet opening 202, which is supplied by the output channel 103. The liquid inlet opening 202 may be located at a bottom of the stimulation device, or on its side, as is shown in FIGS. 2-4, or near the insertion opening 114 where penis enters and exits.

As an alternative optional implementation, the serpentine shape of the partial pipeline is configured in a spatial layout and integrated to be beside or surround the flexible massage body of the sexual massage assembly to reduce space occupancy of the sexual stimulation device. Furthermore, the serpentine shape of the partial pipeline configured in the spatial layout and integrated to be beside or surround the flexible massage body of the sexual massage assembly may provide a preheating function to the flexible massage body.

FIG. 8 is a simplified schematic side view illustrating a manner in which the liquid transfer pipeline 105 connects to the flexible massage body 201, in accordance with exemplary embodiments of the present disclosure. As may be understood from this figure, the output channel 103 of the liquid transfer pipeline 105 enters through the liquid inlet openings 202 so as to coat an interior of the flexible massage body 201. Here, the output channel 103 of the liquid transfer pipeline 105 may have a spiral shape. It is noted that while the illustrated arrangement may appear as a serpentine shape, it is intended to be spiraled in three-dimensions. Moreover, while the output channel 103 of the liquid transfer pipeline 105 may be spaced apart from the flexible massage body 201, for example, with an airgap disposed therebetween, it is to be understood that the output channel 103 of the liquid transfer pipeline 105 may alternatively make contact with the flexible massage body 201.

Here the liquid transfer pipeline 105 is disposed proximate to the sidewall of the flexible massage body 201. This structure utilizes the space between the sidewall of the flexible massage body 201 and the inner wall of the housing 205, thereby providing a longer flow path for the liquid without significantly increasing the overall radial dimensions of the device, which facilitates better heating of the liquid within the liquid transfer pipeline 105 and also the exchange of heat from the liquid transfer pipeline 105 to the flexible massage body 201.

Unlike the implementation illustrated in FIGS. 2-4, in the arrangement shown in FIG. 8, the heating element, such as the rare earth thick film element 106 or the nano thick film layer, of the heating assembly may be directly applied or coated on the outer wall of the spiral section of the liquid transfer pipeline 105. It can be understood that since the heating element is directly coated on the outer wall of the output channel 103, there is no need to rely on a thermal conductive plate 107 as an intermediary for heat transfer. Thus, more efficient heating of the liquid can be achieved. However, in this configuration, due to the requirement for the heating element to be processed on the surface of the spiral pipeline, the total volume of the sexual stimulation device may be larger compared to the sexual stimulation device with the planar disk-shaped coil 109 discussed above.

FIG. 9 is simplified schematic side view illustrating a manner in which the liquid transfer pipeline 105 connects to the flexible massage body 201, in accordance with exemplary embodiments of the present disclosure. Here, a section of the of the liquid transfer pipeline 105 can be designed in a spiral shape and wrap surrounding the flexible massage body 201 in a helical fashion, as shown in this figure. Although the liquid transfer pipeline 105 may be spaced apart from the flexible massage body 201 with an airgap disposed therebetween, it is to be noted that the liquid transfer pipeline 105 may directly contact the liquid transfer pipeline 105 when the flexible massage body 201 expands. The rare earth thick film element 106 may be directly coated on the outer wall of the liquid transfer pipeline similar to the implementation of FIG. 8.

A temperature control structure may be disposed between the rare earth thick film element 106 and the flexible massage body 201 which may be configured to transfer heat from the rare earth thick film element 106 to the flexible massage body and may simultaneously serve to prevent overheating of the flexible massage body 201. In this way, the flexible massage body 201 may also be heated and the user may feel more comfortable during operation.

The temperature of the fluid within the liquid transfer pipeline 105 as well as the temperature of the flexible massage body 201 may thereby be controlled by the temperature control structure, the control module, and the heating element which may be the rare earth thick film element 106, in such a way that overheating may be prevented. This overheating prevention may be active, which is to say, a temperature sensor reads the higher temperature and acts as a monitor to provide feedback of the temperature to the control module to reduce the voltage or the current to the heating element, and/or the overheating prevention may be passive, for example, by incorporating a layer of composite materials or Functionally Graded Materials (FGMs). For the composite materials, at lower temperatures, the composite has a relatively high thermal conductivity, efficiently transferring heat from one subject, such as the heating element, to an object, such as the flexible massage body 201. However, as the temperature rises towards a critical point (e.g., near a desired maximum temperature for the device), the intrinsic properties of one or more constituent materials change. This change causes the overall thermal conductivity of the composite to decrease significantly. This phenomenon, sometimes called “thermal switching” or “thermal rectification,” creates a passive feedback mechanism: increased heat input leads to increased thermal resistance, thereby automatically limiting the heat flux to the device and preventing it from overheating.

The Functionally Graded Materials (FGMs) may be, for example, a special composite material whose composition, microstructure, porosity, and other parameters continuously change in space, resulting in a gradient change in material properties. FGMs passively and intelligently regulate heat flow through their inherent, spatially varying physical properties, achieving a balance between efficient heat transfer and managed temperature distribution.

As discussed above, there may be an airgap or other space between the spiral/helical shaped output channel 103′ of the liquid transfer pipeline 105 and the flexible massage body 201 and this spacing may be particularly apparent when the device is not in use. Then, when the male's penis is inserted into the flexible massage body 201 during use, there is sufficient space for the expansion of the flexible massage body 201 without being bound by the liquid transfer pipeline 105. Moreover, the output channel 103′ of the liquid transfer pipeline 105 may be somewhat flexible so as not to prevent expansion of the flexible massage body 201 during use.

In other implementations, the liquid transfer pipeline 105 maybe spiral/helical shaped and the rare earth thick film element 106 may be disposed on the wall of the liquid transfer pipeline 105, and the temperature control structure may be disposed in the airgap between the spiral/helical shaped liquid transfer pipeline 105 and the flexible massage body 201. The temperature control structure and the flexible massage body 201 may still be spaced apart from one another so as to create an accommodation space for the expanding of the flexible massage body. When the flexible massage body 201 expands and comes into contact with the temperature control structure, the heat of heating assembly (e.g., the rare earth thick film element 106) may be conducted to the flexible massage body 201 via the temperature control structure, and the temperature of the flexible massage body 201 may be prevented from being overheated, thereby a warm and comfortable wrapping sensation and stimulation to the penis of the user could be applied by the flexible massage body 201.

Moreover, to ensure the cleanliness of the liquid, the liquid controller 104 may be configured so as not to come into direct contact with the liquid. The heating assembly, for example, the rare earth thick film element 106, may heat the outer wall of the liquid transfer pipeline 105 without directly contacting the liquid, which can fully ensure the cleanliness of the liquid.

In this embodiment, the liquid transfer assembly may include both a liquid transfer pipeline and a liquid control element. The liquid transfer pipeline includes at least a flexible pipeline section and pipeline section with excellent thermal conductivity (e.g., rigid metal pipeline section). The liquid control element may include a regulator which is configured to contact an outer wall of the flexible pipeline section so as to regulate liquid flow in the flexible pipeline section by blocking or unblocking the pipeline or by adjusting its radial diameter. The pipeline section with excellent thermal conductivity can improve thermal conductivity efficiency of the pipeline section that is in contact with the thermal conductive plate 107 and/or the rare earth thick film element 106 (where the thermal conductive plate 107 is omitted), thus, heat can be quickly conducted from rare earth thick film element 106 to the liquid through the thermal conductive plate 107 and/or pipelines in sequence. The flat disk-like configuration of the pipeline section that contact with the thermal conductive plate 107 may also be used to increase the contact area with the thermal conductive plate 107, which may also be beneficial for rapid heating of liquid.

According to embodiments of the present disclosure, the liquid transfer assembly 102 may include, among other elements, a peristaltic pump. FIG. 10 is a sequence of simplified schematic cutaway views illustrating a peristaltic pump 300 in accordance with exemplary embodiments of the present disclosure.

In some implementations, a liquid output end 301 of the peristaltic pump 300 may connected to a liquid inlet opening of the sexual massage assembly via the liquid transfer pipeline. This configuration forms a liquid delivery pathway with the peristaltic pump 300 as the driving force. The peristaltic pump 300 can be a known component available on the market. Its interior may include a regulator (such as a roller) and a flexible conveyance pipeline wrapped around the regulator (e.g., the two ends of the flexible conveyance pipeline extend to the outside of the peristaltic pump 300 and form the liquid input end and liquid output end of the peristaltic pump 300). The regulator may also be equipped with a pressing wheel capable of compressing the flexible conveyance pipeline. During operation, the peristaltic pump 300 uses the pressing wheel on the rotating roller to alternately compress the internal flexible conveyance pipeline, thereby driving the liquid inside the flexible conveyance pipeline to flow, without any portion of the peristaltic pump 300 making contact with the liquid or otherwise having to expose the liquid to the ambient environment. This allows the liquid inside the storage container to be pumped out, subsequently driving the liquid to flow along the entire pipeline and ultimately delivering it to the sexual massage assembly.

A simplified schematic diagram of working principle of the peristaltic pump 300 is illustrated in FIG. 10. The peristaltic pump 300 is illustrated as being a rotary peristaltic pump in which the rollers 303 rotate about a spindle 304. While embodiments of the present disclosure may well use a linear peristaltic pump which progressively compresses the fluid pathway in a linear fashion, the use of a rotary peristaltic pump may be advantages for implementation in a male-oriented sexual stimulation device that must keep an elongated channel that is largely free of mechanical elements so as to define an open space to accommodate a male penis therein as the rotary peristaltic pump allows for greater design freedom such as the disposition illustrated in FIG. 3 in which the pump may be disposed as the liquid controller 104 shown in that figure.

As may be appreciated from this figure, the peristaltic pump 300 is able to deliver fluid out of its output port 301 with this fluid being forced from the input port 302 by one or more rollers 303 that are configured to push upon the liquid pathway as they are moved by a spindle 304 that they are attached to. In this way, fluid at the input port 302 (shown as the shaded portion of the pathway), as shown in the first peristaltic pump image 300a, is pushed towards the output port 301, as shown in the second peristaltic pump image 300b, and then pushed outwardly so as to exit the peristaltic pump 300, as shown in the third peristaltic pump image 300c.

It is to be understood that in this embodiment, since the heating assembly heats the liquid within the pipeline without contact, and the peristaltic pump 300 does not need to directly contact the liquid when driving the flow of the liquid (e.g., both the heating and flow control of the liquid are performed in a contactless manner) this approach not only effectively prevents the liquid from clogging or affecting the normal operation of the pump due to cooling and increased viscosity but also prevents elements in the device, such as the liquid control element and heating elements themselves, from contaminating the liquid. This ensures the hygienic performance and long-term operational reliability of the device. It is to be understood that as used herein, the term “contactless manner” means that the device responsible for affecting the liquid, be it the heating or movement of the liquid, is configured to never make direct contact with the liquid.

To further enhance the pumping efficiency of the liquid, especially for the lubricant, the storage container 101 may also have an unsealed (e.g., open) structure. For example, the storage container 101 may be a rigid bottle with a vent hole near the bottle opening. In this way, it can avoid poor pumping efficiency due to the influence of air pressure during the process of pumping liquid.

FIG. 11 is a simplified cutaway view illustrating a storage container 101 in accordance with exemplary embodiments of the present disclosure. As can be appreciated from this figure, the storage container 101 may have a main body bladder 400 that contains the liquid (shown with the “+” indicators) and an exit port 401.

The main body bladder 400 of the storage container 101 may be a deformable bladder, which is placed inside a rigid housing or shell 403. A sealed space is formed between the rigid housing 403 and the bladder 400, and the liquid control element may be configured as an air pump. The gas port of the pump is connected to the sealed space inside the rigid housing 403, through an air opening 402, allowing the pump to inflate or deflate the sealed space, thereby altering the internal air pressure of the rigid housing 403. When the air pressure inside the rigid housing 403 increases, it exerts a squeezing effect on the bladder 400 containing the liquid, forcing the liquid inside to flow out through the exit port 401. Thus, by controlling the operation of the air pump, the flow of the liquid can be regulated without the need for a pump, such as liquid pump which would make contact with the liquid. This implementation also achieves contactless control of the liquid by the liquid control element, providing hygiene and contamination prevention effects comparable to those of the peristaltic pump.

Moreover, a flow-stop element may be used to prevent liquid from flowing back to the storage container. The flow-stop element may prevent the liquid in the transfer assembly or in the sexual massage assembly from flowing back to the storage container, thereby avoiding contamination of the liquid inside the storage container.

As noted above, one or more temperature sensors may be used to ensure comfort and safety. At least one temperature sensor may be disposed adjacent to the output channel 103 and/or the liquid inlet openings 202. The disposition of a temperature sensor at this location may be beneficial for accurately monitoring the actual temperature of the liquid about to enter the sexual massage assembly and avoiding scalding the user duo to overheated liquid.

The fluid discussed above, e.g., the lubricant, may be understood to be a first fluid and a first fluid flow may be understood to be the flow of lubricant from the storage container to the sexual massage assembly. However, the liquid transfer assembly 102 may include a liquid controller component configured to control, not only the movement of the first fluid during use, but also the cleaning of the apparatus during a cleaning mode and this cleaning mode may make use of different fluids such as solvents like water and a cleaning solution such as the use of soap or detergent. Thus, the liquid controller component may be configured to control a liquid flow that includes a second fluid flow that may be made to flow from the liquid transfer assembly into the sexual massage assembly. For example, the second fluid may be cleaning liquid, or water, or mixture of cleaning liquid and water, that may be made to flow from the liquid transfer assembly into the sexual massage assembly to wash the sexual massage assembly. In some implementation, the storage container may be detachably connected with the liquid transfer assembly and a second container storing the cleaning liquid and/or water may be connected to the liquid transfer assembly (e.g., the second container may be disposed in the position where the storage container located) after the storage container being detached. Thus, automatic cleaning may be achieved by the cleaning liquid which flows through the liquid transfer assembly into the sexual massage assembly to flush the sexual massage assembly (e.g., an inner wall of the flexible massage body 201) under the operation of the liquid controller component. The flow of the second fluid from the second container storing cleaning liquid and/or water to the sexual massage assembly may be regard as a second fluid flow. As an optional implementation, the cleaning liquid may be extruded from the opening 114 by the user, which is semi-automatic cleaning mode. As other optional implementation, the liquid controller component may be configured to control a liquid flow that includes a third fluid flow. The cleaning liquid in the sexual massage assembly may be extruded back the liquid transfer assembly where it could then be delivered to a waste liquid collector or be extruded from the device as waste though a channel of the liquid transfer assembly, which is a fully automatic cleaning mode. The third fluid flow may be understood to be the flow of the second liquid (e.g., a cleaning liquid) or mixture of semen and the second liquid from the sexual massage assembly to the waste liquid collector or the external ambience.

In some implementations, the storage container may include two segregated storage compartments, one storage compartment is configured to store a first fluid (e.g., a lubricant), and the other is configured to store a second fluid (e.g., a cleaning liquid), the liquid controller component may be configured to control both the first fluid and the second fluid to lubricate the sexual massage assembly and wash the sexual massage assembly after the finish using of the sexual massage assembly. The storage compartment configured to store the second fluid may be regarded as a second container described above.

The liquid controller component may be, or may include, a valve component, such as four-channel valve, five-channel valve, or six-channel valve. The valve of the valve component may be peristaltic pump.

The flow-stop element that prevents liquid from flowing back to the storage container 101 may be disposed near the storage container 101 and the third fluid flow might only flow between the sexual massage assembly and the liquid transfer assembly and may be prevented from flowing into the storage container. In this situation, both the liquid transfer assembly and the sexual massage assembly may be repeatedly washed and cleaned without adversary affecting the remaining liquid stored in the storage container 101.

The device may further include a control module that is connected to the one or more temperature sensors, the liquid control element, and heating assembly. When the temperature sensor observes that the temperature of the liquid exceeds a pre-set temperature threshold, the temperature sensor may send a feedback signal to the control module, and the control module may stop the operation of the liquid control element and the heating assembly (e.g., cutoff the current thereto), thereby preventing overheated liquid entering the flexible massage channel of the sexual massage assembly.

The sexual stimulation device may further include a vibration component 203 that is in close proximity to the flexible massage body 201 or is disposed on sidewall of the flexible massage body 201. For example, the vibration component 203 may be a vibration engine, which provides a vibratory massage effect. The vibration component 203 can be a commonly used structure in the field of sexual stimulation devices.

As mentioned above, embodiments of the present disclosure may be configured to draw fluid from a storage container 101 containing enough fluid for use in multiple operations or may be configured to draw fluid from a single-use capsule. Where the device is configured for use of a single-use capsule, the liquid transfer assembly may be configured to deliver at least part of liquid to the sexual massage assembly from a single-use capsule. Here, the storage container 101 may be connected to the sexual massage assembly via a quick disassembly method. In this embodiment, as the fluid is single use, it may be heated to a target temperature within the storage container 101. It is noted that even though a single-use capsule may be used, embodiments of the present disclosure may still heat the liquid while it is in its fluid path between the capsule and the flexible massage body 201 rather than applying a heating element directly to the capsule. This is because heating the entire capsule may take some time in which the device may be pumping cool fluid or the user would have to wait for a heating cycle to complete prior to use, whereas heating the fluid in-line may allow the user to begin using the device immediately upon power-on, with the fluid at the target temperature.

FIG. 12 is a simplified perspective view illustrating a device that utilizes a single-use capsule for fluid supply, in accordance with an exemplary embodiment of the present disclosure. As may be appreciated from this figure, the device 500 may include a slot 502 for the insertion of the single-use capsule 501. Once snapped into place, fluid may be drawn from the single-use capsule 501 in the slot 502 through a fluid path 503 into the flexible massage body 201.

Thus, the storage container 101 is instantiated as a slot 502 and capsule 501 design that allows for quick disassembly by which a spent capsule 501 may be ejected and a new capsule 501 inserted quickly and without the need for tools. The capsule 501 may be bound into the slot 502 by means such as a buckling connection, snap-fit connection, magnetic connection, threaded connection, and so on.

To heat the liquid, a small heater may be installed inside the device 500 to heat the entire storage container 101 after the capsule 501 is properly positioned within the slot 502. Since the liquid in the storage container 101 will be used up entirely at every use, there is no risk of deteriorating the liquid's properties due to repeated heating. Therefore, the goal of providing warm liquid during operation, without reheating liquid and without wasting liquid, may be achieved. Additionally, this approach may help simplify heating structures within the device, utilizing only a simple resistive heating element proximate to the slot 502, without the need to instantaneous heat the liquid as it travels through the fluid path 503.

The device may further include additional elements commonly used in electronic devices, such as buttons, wires, display screens, charging hardware, microprocessors, system-on-chip elements, computer memory, computer storage, waterproofing seals and coatings, protective skins, connection ports/pins, communications radios for smart control etc.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A dispenser for heated liquid, comprising:
a storage container configured to store liquid;
an output portion configured to output at least part of the liquid at a target temperature to achieve tactile comfort for a sensitive area of a user; and
a liquid transfer assembly configured to deliver the at least part of the liquid from the storage container to the output portion while preserving the liquid remained in the storage container at an initial temperature,
wherein the target temperature of the at least part of the liquid is higher than the initial temperature of the liquid remained in the storage container.

2. The dispenser according to claim 1, further comprising a heating assembly configured to heat the at least part of the liquid to the target temperature as it moves through the liquid transfer assembly.

3. The dispenser according to claim 2, wherein the heating assembly is an instantaneous on-demand heating assembly.

4. The dispenser according to claim 2, wherein the heating assembly is configured to have a heating rate of not less than 20° C./s from room temperature.

5. The dispenser according to claim 2, wherein the heating assembly is configured to heat the at least part of the liquid to the target temperature as it moves through the heating assembly, in a contactless manner.

6. The dispenser according to claim 2, wherein the heating assembly includes a rare earth thick film element or a nanostructured thick film element.

7. The dispenser according to claim 2, wherein an outer layer of the heating assembly includes a thermal insulation structure.

8. The dispenser according to claim 1, wherein the liquid transfer assembly includes a liquid controller configured to control a flow of the at least part of the liquid, in a contactless manner.

9. The dispenser according to claim 1, wherein the liquid transfer assembly includes a peristaltic pump.

10. The dispenser according to claim 8, wherein the liquid transfer assembly includes a flexible pipeline section, and wherein the liquid controller includes a regulator that contacts an outer wall of the flexible pipeline section to regulate liquid flow in the flexible pipeline section.

11. The dispenser according to claim 1, further comprising one or more temperature sensors, at least one of which is disposed adjacent to the output portion.

12. A sexual stimulation device, comprising:
a storage container configured to store liquid;
a sexual massage assembly configured to apply sexual stimulation to a sensitive area of a user; and
a liquid transfer assembly configured to deliver at least part of the liquid from the storage container and output the at least part of the liquid to the sexual massage assembly at a target temperature to achieve tactile comfort for the sensitive area of the user while preserving the liquid remained in the storage container at an initial temperature,
wherein the target temperature of the at least part of the liquid is higher than the initial temperature of the liquid remained in the storage container.

13. The sexual stimulation device according to claim 12, wherein at least a partial pipeline of the liquid transfer assembly is configured in a serpentine or maze shape to lengthen a preheating and flow path of the liquid transfer assembly.

14. The sexual stimulation device according to claim 13, wherein the serpentine or maze shape of the partial pipeline is configured in a flat layout and integrated to a bottom of a flexible massage body of the sexual massage assembly to reduce space occupancy of the sexual stimulation device.

15. The sexual stimulation device according to claim 13, wherein the serpentine shape of the partial pipeline is configured in a spatial layout and integrated to be beside or surround a flexible massage body of the sexual massage assembly to reduce space occupancy of the sexual stimulation device and provide a preheating function to the flexible massage body.

16. The sexual stimulation device according to claim 12, wherein the liquid transfer assembly is configured to indirectly heat the sexual massage assembly by delivering the at least part of the liquid, at the target temperature, so as to apply warm tactile stimulation to the sensitive area of the user as the at least part of the liquid, at the target temperature, moves through an output portion to the sexual massage assembly.

17. The sexual stimulation device according to claim 12, wherein the sexual massage assembly is a male-oriented sexual stimulation assembly including a flexible massage channel, wherein the liquid transfer assembly is configured to deliver the at least part of the liquid to the flexible massage channel.

18. The sexual stimulation device according to claim 12, wherein the liquid transfer assembly includes a liquid controller component configured to:
control a flow of the liquid, which constitutes a first liquid, from the storage container to the sexual massage assembly; and
control a flow of a second fluid from a second container storing cleaning liquid and/or water to the sexual massage assembly.

19. The sexual stimulation device according to claim 12, wherein the storage container is connected to the sexual massage assembly via a quick disassembly arrangement.

20. The sexual stimulation device according to claim 19, wherein the storage container includes a slot configured to receive a single-use capsule that includes only the at least part of the liquid.
